(19) United States
(12) Patent Application Publication
(10) Pub. No.: US 2007/0201068 A1
(43) Pub. Date: Aug. 30, 2007

(54) JOB PROGRESS DISPLAY DEVICE AND METHOD FOR DISPLAYING JOB PROGRESS

(75) Inventor: Yoshitaka Matsuki, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/424,542

(22) Filed: Jun. 16, 2006

(30) Foreign Application Priority Data
Jun. 16, 2005 (JP) 2005-175833

(51) Int. Cl. G06F 3/12

(52) U.S. Cl. 358/1.13

(57) ABSTRACT

A job progress display device that allows a user to clearly identify the timing at which a print job will be processed, and a method for performing the same, are disclosed. A job progress display device that displays the progress of a plurality of print jobs for which a spool process is executed includes a progress display bar display unit configured to display the progress of the plurality of print jobs as a progress display bar. The progress display bar display unit displays the order in which the plurality of print jobs will be performed, and the quantity of data in each print job, in segment regions so that that they can be identified by a user.

### CROSS-REFERENCE TO RELATED APPLICATIONS

This application claims priority to Japanese Patent Application No. 2005-175833. The entire disclosure of Japanese Patent Application No. 2005-175833 is hereby incorporated herein by reference.

### BACKGROUND OF THE INVENTION

1. Field of the Invention

The present invention relates to a job progress display device for displaying the job progress of a plurality of print jobs for which a spool operation is executed, and a method for performing the same.

2. Background Information

Recently, an image processing device such as a printer, a copying machine, a facsimile, and multifunction device which includes the functions of these devices, also includes a local user interface (or a local UI) and a remote user interface (a remote UI), and can thereby perform processes such as image output not only by operating the main unit of an image processing device, but also by remote operation of an information processing device (i.e., a host computer).

However, the image output speed is generally much slower than the processing speed of a microprocessor in these image processing devices, and thus a spool operation will be executed. The spool operation is one in which data corresponding to each print job is temporarily stored in a storage unit such as a hard disc drive, and gradually processed in accordance with the image output status.

In a spool operation, an image processing device temporarily stores a plurality of print jobs (print job data) that are input through the image processing device, or through a plurality of information processing devices, in a storage device such as a hard disc drive, and sequentially despools each of the plurality ofprintjobs. For example, Japan Patent Application Publication JP-A-2003-103845 discloses a means for displaying the job progress of print jobs for which a despool operation has begun execution. However, a means has yet to be produced which will allow a user of an image processing device or a plurality of information processing devices to clearly identify the timing at which a print job requested by the user will be processed. Therefore, this type of inconvenience has been a problem.

It is therefore an object of the present invention to provide a job progress display device by which a user can clearly identify the timing at which a print job requested by a user will be processed, and a method for performing the same. This invention addresses this need in the art as well as other needs, which will become apparent to those skilled in the art from this disclosure.

### SUMMARY OF THE INVENTION

To achieve the above described object, according to a first aspect of the present invention, a job progress display device is configured to display the progress of a plurality of print jobs for which a spool process is executed. The job progress display device comprises a progress display bar display unit configured to display the progress of the plurality of print jobs as a progress display bar. In addition, the progress display bar display unit displays the order in which the plurality of print jobs will be processed, and the quantity of data in each print job, in segmented regions in the progress display bar so as to be identifiable by a user.

The above described configuration will allow a user to clearly identify the timing at which each of the plurality of print jobs will be processed based on the order in which the print jobs are displayed, and the quantity of data in each print job. In other words, it is possible to provide a job progress display device by which a user can clearly identify the timing at which the plurality of print jobs will be processed.

According to a second aspect of the present invention, the job progress display device in accordance with the first aspect of the present invention further comprises a region marker unit configured to display a marker with respect to a predetermined segment region in the progress display bar.

For example, if the region marker display unit displays a marker with respect to a print job requested by a specific user, the above described configuration will allow the specific user to clearly identify the timing at which the requested print job will be processed. In other words, it is possible to provide a job progress display device by which a user can clearly identify the timing at which a requested print job will be processed.

According to a third aspect of the present invention, in the job progress display device in accordance with the second aspect of the present invention, the marker display unit will regulate the types of markers to be displayed so that the markers will be different from each other when displaying markers with respect to a plurality of segment regions. Because of this, it is possible to prevent misidentification of a print job caused by simultaneously displaying a plurality of the same type of markers.

According to a fourth aspect of the present invention, the job progress display device in accordance with the first aspect of the present invention further comprises a despool marker display unit configured to display a marker with respect to a segment region in the progress display bar which corresponds to a print job for which a despool processing is being executed.

The above described configuration makes it possible for a user to easily identify a segment region corresponding to a print job for which a despool process is being executed, and moreover, clearly identify the timing at which a print job will be processed based on the order in which the segment region is displayed that corresponds to the print job.

According to a fifth aspect of the present invention, the job progress display device in accordance with the first aspect of the present invention further comprises a basic attribute display unit configured to display an attribute of a print job corresponding to a segment region in the progress display bar. Because of this, a user can easily identify a print job corresponding to each of the segment regions.

According to a sixth aspect of the present invention, the job progress display device in accordance with the first aspect of the present invention further comprises a detailed attribute display unit configured to display the detailed attributes of a print job that has been selected for deletion. This allows a user to confirm the content of a print job before the print job is deleted, and will prevent a user from deleting a print job by mistake.

According to a seventh aspect of the present invention, a job progress display method is disclosed which displays the progress of a plurality of print jobs for which a spool process is executed. The job progress display method comprises the step of displaying a progress display bar that is divided into segment regions, so that the order in which the plurality of print jobs job, and the quantity of data in each of the plurality of print jobs, can be identified by a user.

According to an eighth aspect of the present invention, in the job progress display method in accordance with the seventh aspect of the present invention, a marker is displayed with respect to a predetermined segment region in the progress display bar.

According to a ninth aspect of the present invention, in the job progress display method in accordance with the eighth aspect of the present invention, markers are displayed with respect to a plurality of segment regions, and regulated so as to be different from each other.

According to a tenth aspect of the present invention, in the job progress display method in accordance with the seventh aspect of the present invention, a marker is displayed with respect to a segment region in the progress display bar, the marker corresponding to a print job for which a despool process is being executed.

According to an eleventh aspect of the present invention, in the job progress display method in accordance with the seventh aspect of the present invention, an attribute of a print job corresponding to a selected segment region in the progress display bar will be displayed.

According to a twelfth aspect of the present invention, in the job progress display method in accordance with the seventh aspect of the present invention, an attribute of a print job that is selected for deletion will be displayed.

As described above, the present invention provides a job progress display device by which a user can clearly identify the timing at which a print job requested by the user will be processed, and a method for performing the same.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a functional block diagram showing the configuration of an image processing system capable of displaying the progress of a print job;

FIG. 2 shows the overall configuration of the image processing system;

FIG. 3 shows the main portions of an image processing device;

FIG. 4 is a flow chart for describing a series of operations performed by a spool processing unit;

FIG. 5A shows a progress display bar comprised of a segment region and a progress display bar guide;

FIG. 5B shows a progress display bar comprised of four segment regions and the progress display bar guide;

FIG. 5C shows a progress display bar in which the segment regions are shifted in the progress display bar guide;

FIG. 6 is a flow chart for describing a series of operations executed by a progress display bar display unit;

FIG. 7A shows a region marker in the progress display bar guide;

FIG. 7B is a diagram for describing the despool process;

FIG. 7C shows a basic attribute of a print job displayed in a segment region;

FIG. 7D shows detailed attributes of a print job displayed in a segment region;

FIG. 8 is a flow chart for describing a series of operations executed by a display unit mounted on an image processing device;

FIG. 9 is a flow chart for describing a series of operations executed by a display unit mounted on a personal computer; and

FIG. 10 shows a progress display bar in progress display bar guide, in which each of the segment regions are displayed with a different marker.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

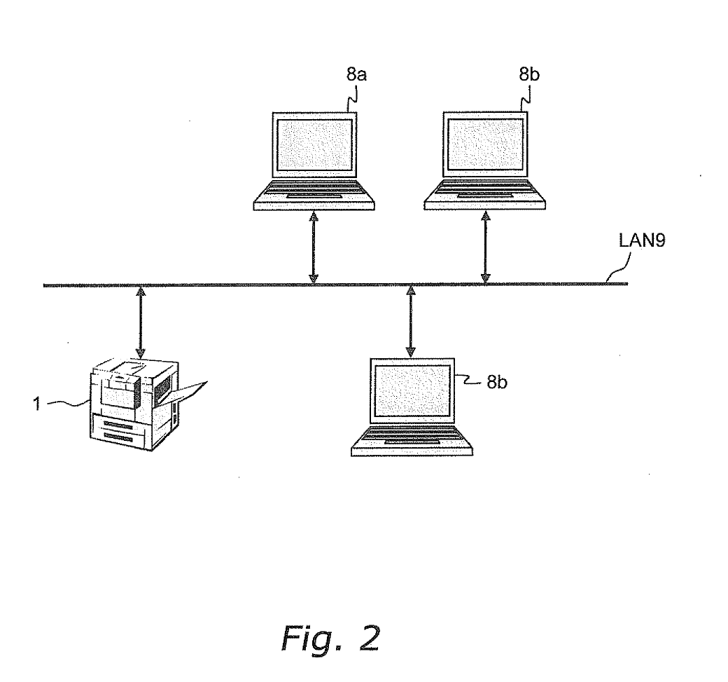

An image processing system comprises a job progress display device, and a method for displaying job progress, in accordance with the present invention. As shown in FIG. 2, a digital copying machine 1 functioning as an image processing device, and a plurality of image processing devices (i.e., external devices) including a remote UI, such as three image processing devices 8a, 8b, and 8c, are connected through a network such as a local area network (LAN) 9 in the image processing system.

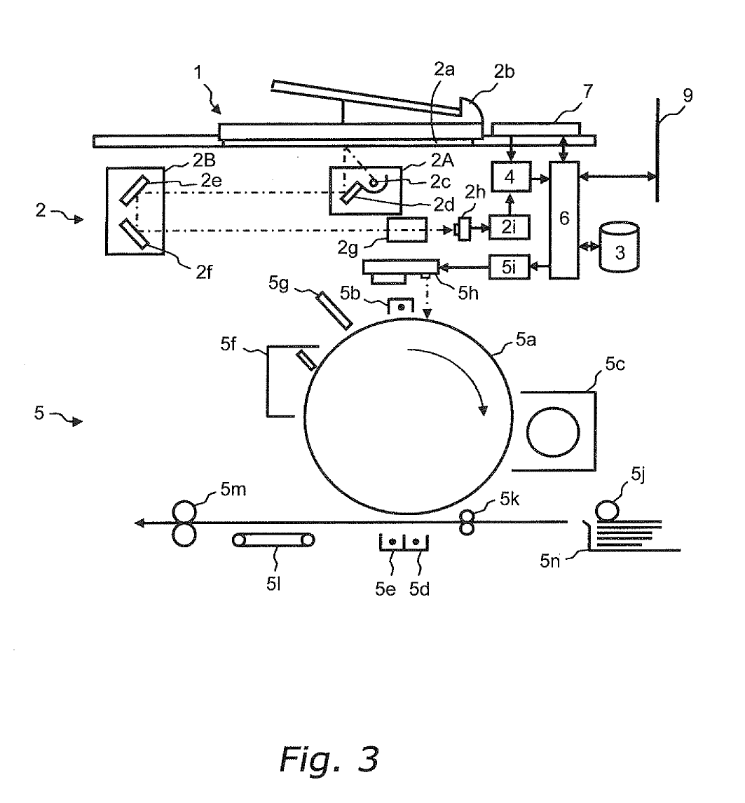

As shown in FIG. 3, the digital copying machine 1 is configured to comprise an operation display unit 7, an image information input unit 2, a print job generating unit 4, a spool processing unit 6, and an image processing unit 5. The operation display unit 7 includes a local UI. The image information input unit 2 inputs image information. The print job generating unit 4 generates a print job based on the image information input by means of the image information input unit 2 and one or more operating instructions from the operation display unit 7. The spool processing unit 6 performs spool processing (to be described below), in which a storage unit 3 is instructed to store the print jobs generated by the print job generating unit 4 and the print jobs input by each of the information processing devices 8a, 8b, and 8c through the LAN 9, and despool processing is sequentially performed with respect to the print jobs. The image processing unit 5 performs predetermined image forming processing based on the print jobs for which spool processing is to be performed. Note that a control board configured to comprise a microcomputer, a read-only memory (ROM), a random access memory (RAM), an output driver circuit, and an input buffer circuit, implemented on each of control blocks.

The image information input unit 2 is comprised of an automatic document feeder 2b, a first slider 2A, a second slider 2B, a solid-state image sensor 2h, and a input image processing unit 2i. The automatic document feeder 2b is disposed on a contact glass 2a. The first slider 2A comprises an exposure lamp 2c that scans a document fed on the contact glass 2a by the automatic document feeder 2b, and a first mirror 2d that reflects the reflected light from a document. The second slider 2B comprises second and third mirrors 2e and 2f which guide the light reflected by the first mirror 2d to a condenser lens 2g. The solid-state image sensor 2h converts optical information from the condenser lens 2g into an electrical signal. The input image processing unit 2i performs operations such as quantized processing through which an output signal from the solid-state image sensor 2h is converted into digital data as the image information, a denoising processing, and a compression processing.

The image processing unit 5 is configured to comprise an image forming unit and a recording sheet feeder. The image forming unit of the image processing unit 5 is configured to comprise an electrostatic unit 5b, a developing unit 5c, a toner image transferring discharge unit 5d, a recording sheet removing discharge unit 5e, a cleaning unit 5f, and a charge removing unit 5g, which are arranged around a photosensitive drum 5a in the above order in the rotational direction of the photosensitive drum 5a. The photosensitive drum 5a is rotated and driven by a main drive motor (not shown in the figure) in the rotational direction indicated by an arrow shown in FIG. 3. The electrostatic unit 5b charges a photosensitive layer formed on the surface of the photosensitive drum 5a. The developing unit 5c converts a latent image formed on the photosensitive layer into a toner image. The toner image transferring discharge unit 5d transfers the toner image formed on the photosensitive layer onto a recording sheet. The recording sheet removing discharge unit 5e removes the recording sheet from the photosensitive drum 5a. The cleaning unit 5f removes the toner remaining on the photosensitive drum 5a after completing the transfer of the toner image. The charge removing unit 5g removes charges on the surface of the photosensitive drum 5a. Here, a laser is radiated from a laser unit 5h onto the photosensitive layer that is uniformly electrostatically charged by the electrostatic unit 5b, based on the print job that is read out from the storage unit 3 and uncompressed in a bitmap memory 5i after expansion processing, and to thereby form a latent image. Then, a toner image is formed by the developing unit 5c.

The recording sheet feeder of the image processing unit 5 comprises a sheet supply roller 5j, a pair of resist rollers 5k, and a transport belt 51. The sheet supply roller 5j supplies a recording sheet that is stored in a sheet supply cassette 5n. The pair of resist rollers 5k transports a recording sheet that is transported thereto by the sheet supply roller 5j to the photosensitive drum 5a at a predetermined timing. The transport belt 51 transports the recording sheet on which the toner image is transferred and which is removed from the photosensitive drum 5a to a fixing roller 5m. The recording sheet on which the image is fixed by the fixing roller 5m is discharged onto a discharge tray via a discharge mechanism (not shown in the figure).

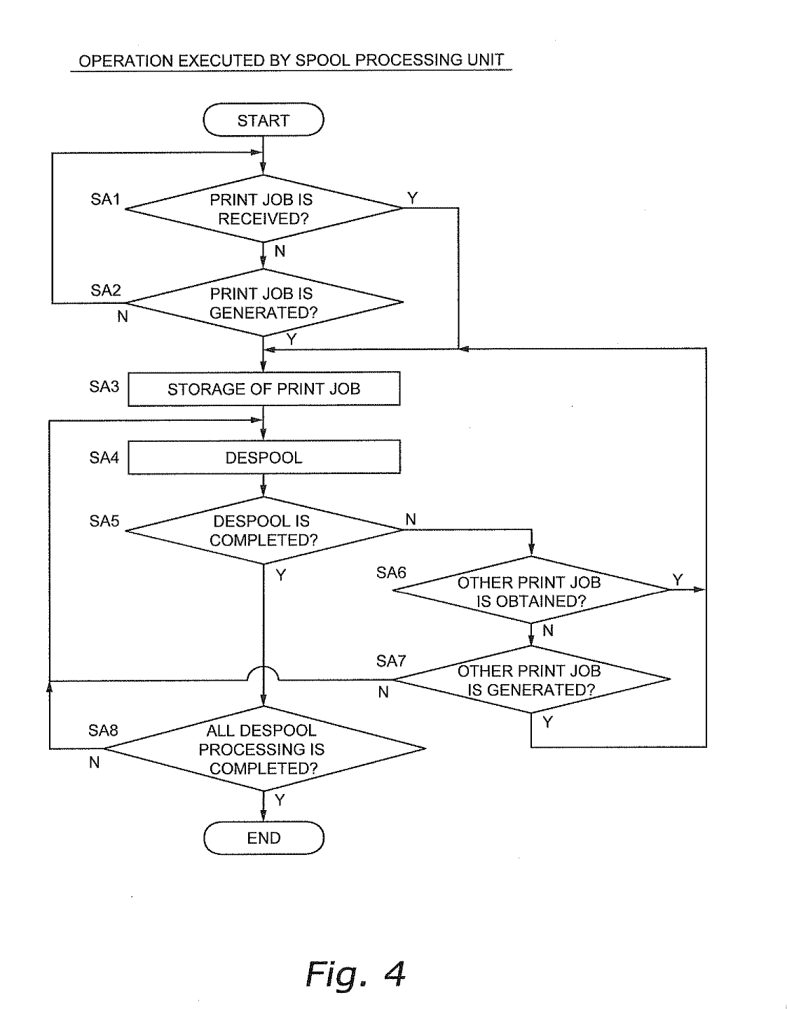

Based on the flow chart shown in FIG. 4, a series of spool processes executed by a spool processing unit 6 will be hereinafter described. If a print job is output from the information processing device 8a to the digital multifunction device 1 and the digital copying machine 1 receives the print job (Step SA1), or if a print job is generated by the print job generating unit 4 in the digital multifunction device 1 (Step SA2), the spool processing unit 6 will begin executing a spool process.

In other words, the spool processing unit 6 will instruct the storage unit 3 to store the print (Step SA3), and despool the print job stored in the storage unit 3 to the image processing unit 5 (Step SA4).

In addition, if other print jobs are obtained or generated (Step SA6 or Step SA7) while the despool process is executed (Step SA5), the spool processing unit will instruct the storage unit 3 to store the other print jobs (Step SA3), and despool the other print jobs according to the order in which the other print jobs are stored in the storage unit 3 after completion of the despool processing of the previous print job (Step SA4). Then, when all the despool processing for the print jobs stored in the storage unit 3 is completed (Step S8), the spool processing unit 6 will terminate the spool processing.

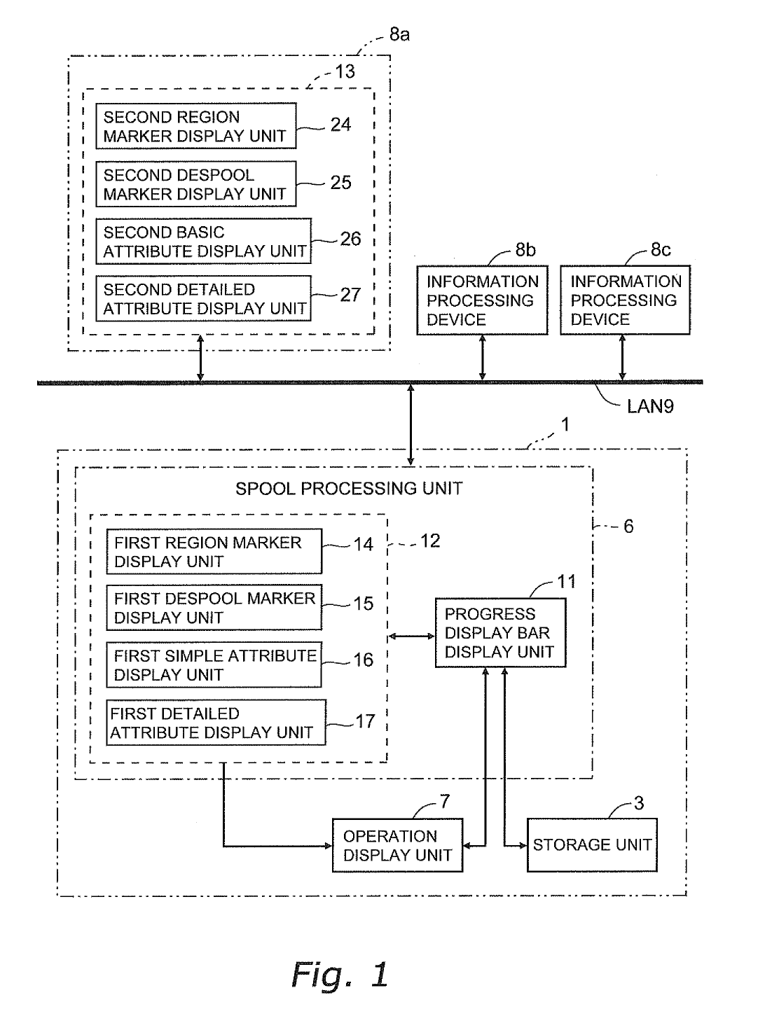

As shown in FIG. 1, a progress display bar display unit 11 and a display 12 of the image processing device, both of which are included in the spool processing unit 6, and a display unit 13 of the PC, which is included in each of the information processing devices 8a, 8b, and 8c, are involved in the function of displaying the progress of the print jobs in the image processing system. The progress display bar display unit 11 instructs the operation display unit 7 and each of the information processing devices 8a, 8b, and 8c to display the progress of a plurality of print jobs, for which the spool processing unit 6 performs spooling processing, as a progress display bar. The display unit 12 of the image processing device is also included in the spool processing unit 6, and optionally instructs the operation display unit 7 to display a predetermined marker and/or one or more attributes for a print job. The display unit 13 of the PC optionally instructs each of the information processing devices 8a, 8b, and 8c to display a predetermined marker and/or one or more attributes of a print job. Note that the information processing devices 8a, 8b, and 8c have the same configuration. Therefore, the configurations of the information processing devices 8a, 8b, and 8c will be hereinafter described by describing only the configuration of the information processing device 8a.

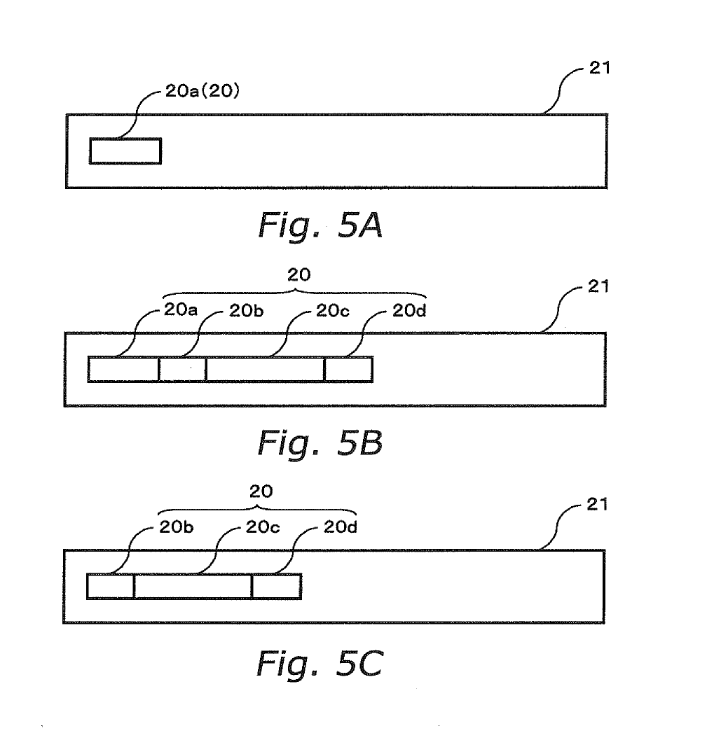

The progress display bar display unit 11 is configured to detect the order in which a plurality of print jobs is to be performed, and also detect the quantity of data in each print job. In addition, as shown in FIG. 5B, the progress display bar display unit 11 is configured to instruct the operation display unit 7 and each of the information processing devices 8a, 8b, and 8c to display a progress display bar 20 and a progress display bar guide 21, for instance. The progress display bar 20 is formed by connecting segment regions 20a, 20b, 20c, and 20d, for instance. The segment regions 20a to 20d are arranged from left to right according to the order in which the print jobs are to be performed, and each horizontal length of the segment regions 20a to 20d corresponds to the quantity of data in each print job. In other words, the progress display bar 20 makes it possible for a user to identify the order in which a plurality of print jobs will be performed, and the quantity of data in each print job. The progress display bar guide 21 indicates the region in which the progress display bar 20 is shown.

Note that the progress display bar display unit 11 is configured to instruct the storage unit 3 to store information corresponding to each segment region as spool information by associating the information with each segment region. For example, the information stored in the storage unit 3 includes the file name of each print job, information on the digital copying machine 1 or the information processing device through which a print job is input to the digital copying machine 1, the login user name, and the like.

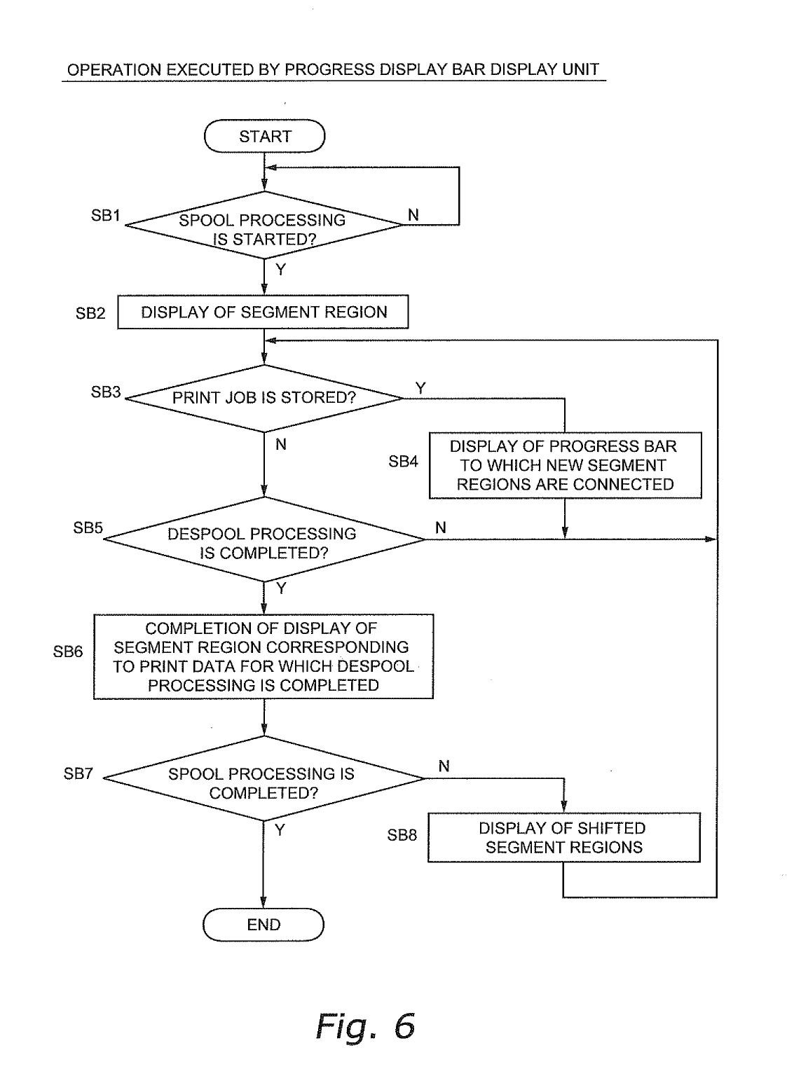

Based on the flow chart shown in FIG. 6, a series of operations executed by the progress display bar display unit 11 will be hereinafter described. If the spool processing unit 6 starts to execute spool processing (Step SB1), the progress display bar display unit 11 will instruct the operation display unit 7 and each of the information processing devices 8a, 8b, and 8c to display the progress display bar guide 21, which provides a region in which the progress display bar 20 is displayed, and the progress display bar 20, which is comprised of a segment region 20a having a horizontal length that corresponds to the quantity of data in the print job stored in the storage unit 3, as shown in FIG. 5A (Step SB2).

In addition, if other print jobs are stored in the storage unit 3 (Step SB3), the progress display bar display unit 11 will instruct the operation display unit 7 and each of the information processing devices 8a, 8b, and 8c to display an updated progress display bar 20 (Step SB4). As shown in FIG. 5B, the updated progress display bar 20 further comprises new segment regions that each have a length corresponding to the quantity of data in the print job represented thereby (e.g., segment regions 20b, 20c, and 20d), and are displayed on the right side of the segment region 20a so as to be arranged from left to right in the order that they are stored in the storage unit 3.

If the despool process for a print job is completed, e.g., if the despool process for the print job corresponding to the segment region 20a is completed (Step SB5), the progress display bar display unit 11 will instruct the operation display unit 7 and each of the information processing devices 8a, 8b, and 8c to stop displaying the segmented region 20a (Step SB6). On the other hand, if other print jobs remain in the storage unit 3, i.e., if the spool process has not yet been completed (Step SB7), the progress display bar display unit 11 will instruct the operation display unit 7 and each of the information processing devices 8a, 8b, and 8c to display the other segmented regions (e.g., the segmented regions 20b, 20c, and 20d) so that they are sequentially shifted to the left, as shown in FIG. 5C (Step SB8).

Referring to FIG. 1 again, the display unit 12 of the image processing device will optionally instruct the operation display unit 7 to display a predetermined marker and/or one or more attributes of a print job based on the spool information. The display unit 12 of the image processing device is configured to comprise a first region marker display unit 14, a first despool marker display unit 15, a first basic attribute display unit 16, and a first detailed attribute display unit 17. The first region marker display unit 14 displays a predetermined region marker with respect to a predetermined segment region in the progress display bar 20 that is displayed by the progress display bar display unit 11. The first despool marker display unit 15 displays a predetermined despool marker with respect to a segment region in the progress display bar 20 corresponding to the print job for which the despool process is being performed. The first basic attribute display unit 16 displays one basic attribute of the print job corresponding to a segment region in the progress display bar 20 selected by a user through the operation display unit 7. The first detailed attribute display unit 17 displays detailed attributes of a print job which has been selected for deletion by a user through the operation display unit 7.

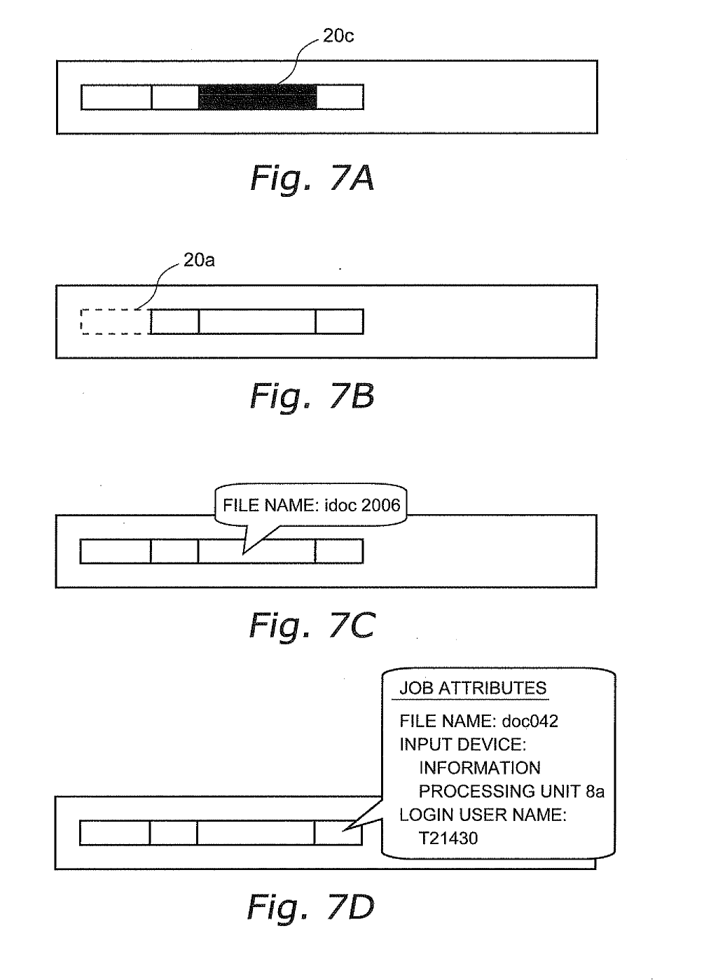

The first region marker display unit 14 can display and superimpose a predetermined region marker on a segment region in the progress display bar 20 displayed on the operation display unit 7, which corresponds to a print job generated by the digital copying machine 1. For example, if the segmented region 20c is a segment region corresponding to a print job generated by the digital copying machine 1, the first region marker display unit 14 can display and superimpose the predetermined region marker on the segmented region 20c. For example, as shown in FIG. 7A, the first region marker display unit 14 is configured to display a predetermined color that functions as a region marker to be superimposed on the segmented region 20c.

The first despool marker display unit 15 can display and superimpose a predetermined despool marker on the segment region in the progress display bar 20 displayed on the operation display unit 7, which corresponds to a print job for which the despool process is currently being performed by the spool processing unit 6. For example, if the segment region 20a is a segment region corresponding to a print job for which the despool process is being preformed, the first despool marker display unit 15 will display and superimpose a predetermined despool marker on the segment region 20a. For example, as shown in FIG. 7B, the first despool marker display unit 15 is configured to display and superimpose a despool marker on the segment region 20a so that the segment region 20a will flash on and off so as to be more visible to the user.

The first basic attribute display unit 16 can instruct the operation display unit 7 to display one basic attribute of a print job corresponding to a segment region in the progress display bar 20, which is selected by a user through the operation display unit 7. For example, as shown in FIG. 7C, the first basic attribute display unit 16 is configured to instruct the operation display unit 7 to display the file name of a print job using a text balloon.

The first detailed attribute display unit 17 can instruct the operation display unit 7 to display detailed attributes of a print job that has been selected for deletion by a user through the operation display unit 7. For example, as shown in FIG. 7D, the first detailed attribute display unit 17 is configured to display the file name of the print job, information on the digital copying machine 1 or the information processing device through which the print job is input to the digital copying machine 1, the login user name, and the like.

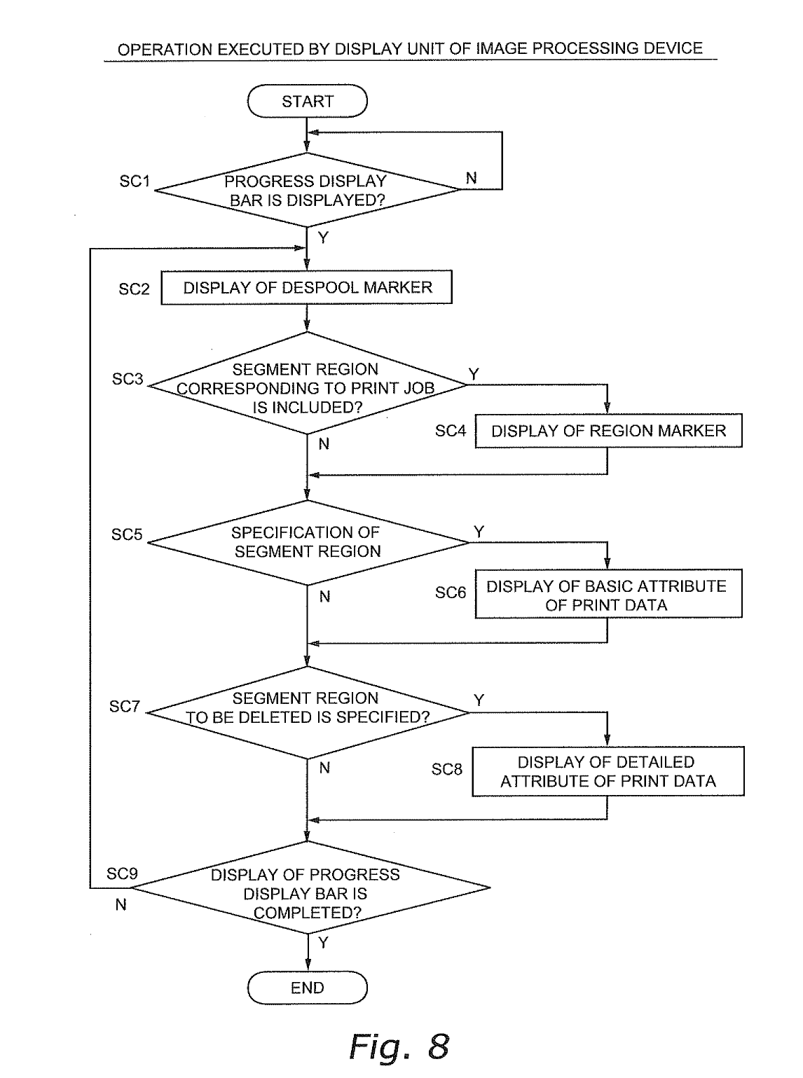

Based on the flow chart shown in FIG. 8, a series of operations executed by the display unit 12 of the image processing device will be hereinafter described. If the progress display bar 20 is displayed on the operation display unit 7 (Step SC1), the first despool marker display unit 15 will display and superimpose a despool marker on the segment region in the progress display bar 20 displayed on the operation display unit 7, which corresponds to a print job for which the despool process is currently being performed by the spool processing unit 6, so that the segment region will flash on and off so as to be more visible to the user (Step SC2).

In addition, if a segment region corresponding to a print job generated by the digital copying machine 1 is included in the progress display bar 20 (Step SC3), the first region marker display unit 14 will display and superimpose a predetermined color that will function as a region marker on the segment region (Step SC4).

If a user selects any of the segment regions in the progress display bar 20 through the operation display unit 7 (Step SC5), the first basic attribute display unit 16 will, for example, instruct the operation display unit 7 to display the file name of a print job corresponding to the selected segment region (Step SC6).

In addition, if a user selects any of the segment regions in the progress display bar 20 for deletion through the operation display unit 7 (Step SC7), the first detailed attribute display unit 17 will, for example, instruct the operation display unit 7 to display the file name of the print job corresponding to the segment region selected for deletion, information on the digital copying machine 1 or the information processing device through which the print job is input to the digital copying machine 1, the login user name, and the like (Step SC8).

In addition, while the progress display bar 20 is displayed on the operation display unit 7, Steps SC2 to SC8 are repeated (Step SC9).

Referring to FIG. 1 again, the display unit 13 of the PC can instruct the information processing device 8a to display a predetermined marker and/or one or more attributes of a print job based on the spool information. The display unit 13 of the PC is comprised of a second region marker display unit 24, a second despool marker display unit 25, a second basic attribute display unit 26, and a second detailed attribute display unit 27. The second region marker display unit 24 displays a region marker with respect to a predetermined segment region in the progress display bar 20 displayed by the progress display bar display unit 11. The second despool marker display unit 25 displays a despool marker with respect to a segment region in the progress display bar 20, which corresponds to a print job for which the despool process is being performed. The second basic attribute display unit 26 displays one basic attribute of a print job corresponding to the segment region in the progress display bar 20, which is selected by a user through the information processing device 8a. The second detailed attribute display unit 27 displays detailed attributes of a print job that has been selected for deletion by a user through the information processing device 8a.

The second region marker display unit 24 can display and superimpose a predetermined region marker on a segment region in the progress display bar 20 displayed in the information processing device 8a, which corresponds to a print job output from the information processing device 8a. For example, the second region marker display unit 24 is configured to display a predetermined color on the segment region.

The second despool marker display unit 25 can display and superimpose a predetermined despool marker on a segment region in the progress display bar 20 displayed in the information processing device 8a, which corresponds to a print job for which a despool process is being performed by the spool processing unit 6. For example, the second despool marker display unit 25 is configured to display and superimpose a despool marker on the segment region so that the segment region will flash on and off so as to be more visible to the user.

The second basic attribute display unit 26 will instruct the information processing device 8a to display one basic attribute of the print job corresponding to a segment region in the progress display bar 20 selected by a user through the information processing device 8a. For example, the second basic attribute display unit 26 is configured to display the file name of a print job using a text balloon.

The second detailed attribute display unit 27 will instruct the information processing device 8a to display detailed attributes of a print job selected for deletion by a user through the information processing device 8a. For example, the second detailed attribute display unit 27 is configured to display the file name of a print job, the digital copying machine 1 or the information processing device through which the print job is input to the digital copying machine 1, the login user name, and the like.

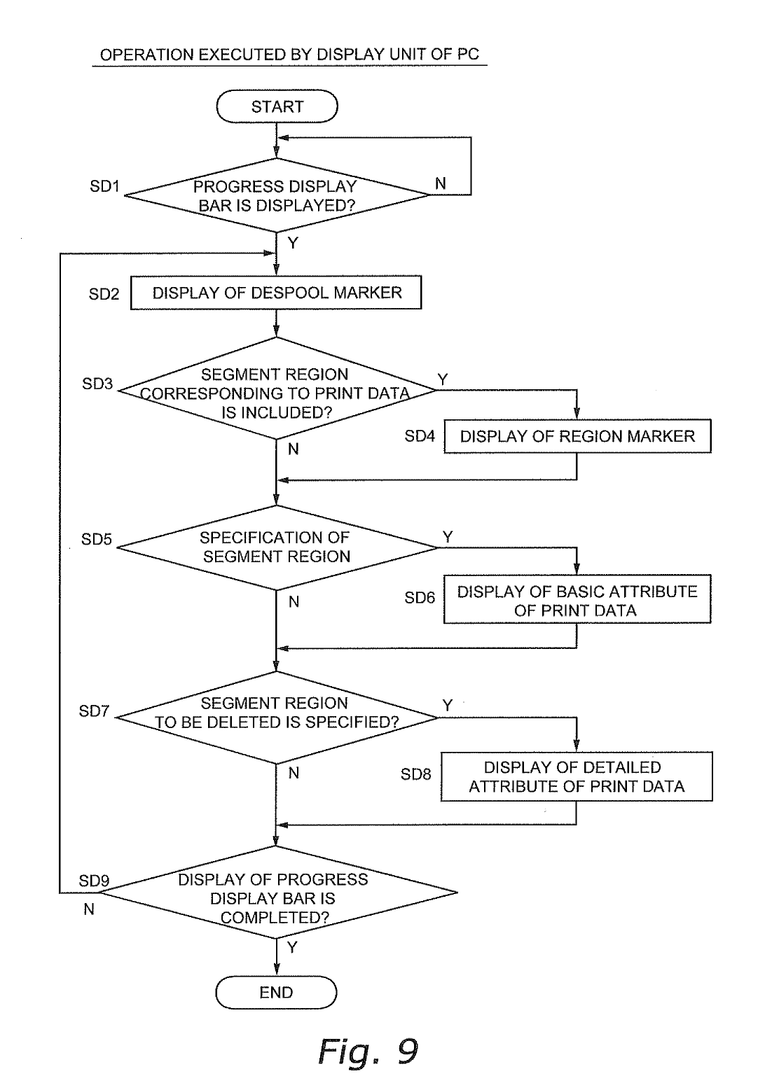

Based on the flow chart shown in FIG. 9, a series of operations of the display unit 13 of the PC will be hereinafter described. If the progress display bar 20 is displayed in the information processing device 8a (Step SD1), the second despool marker display unit 25 can display and superimpose a despool marker on a segment region in the progress display bar 20 displayed in the information processing device 8a, which corresponds to a print job for which the despool process is currently being performed by the spool processing unit 6, so that the segment region will flash on and off so as to be more visible to the user (Step SD2).

In addition, if a segment region corresponding to a print job output from the information processing device 8a is included in the progress display bar 20 (Step SD3), the second region marker display unit 24 will display a predetermined color that functions as a region marker on the segment region (Step SD4).

If any of the segment regions in the progress display bar 20 is selected by a user through the information processing device 8a (Step SD5), the second basic attribute display unit 26 will, for example, instruct the information processing device 8a to display the file name as a basic attribute of the print job corresponding to the selected segment region (Step SD6).

In addition, if any of the segment regions in the progress display bar 20 is selected for deletion by a user through the information processing device 8a (Step SD7), the second detailed attribute display unit 27 will instruct the information processing device 8a to display the file name of the print job, information on the digital copying machine 1 or the information processing device 1 through which the print job is input to the digital copying machine 1, the login user name, and the like (Step SD8).

Then, while the progress display bar 20 is being displayed in the information processing device 8a, Steps SD2 to SD8 are repeated (Step SD9).

In other words, each user who has requested a print job with respect to the digital copying machine 1 through the operation display unit 7 and each of the information processing devices 8a, 8b, and 8c, will be able to clearly identify the timing at which each of the requested print jobs will be processed.

### Modifications

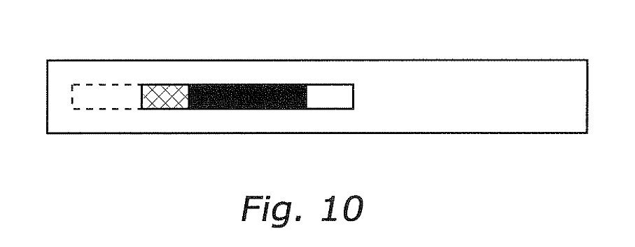

Modifications of the above describe embodiment will be hereinafter described. The above described embodiment describes a situation in which the first region marker display unit 14 can display and superimpose a predetermined color that functions as a region marker on the segment region in the progress display bar 20 displayed in the operation display unit 7, which corresponds to a print job generated by the digital copying machine 1. However, the region marker is not limited to a predetermined color, and a variety of patterns or signs can be selected as the region marker as needed. In addition, if there are a plurality of segment regions in the progress display bar 20 displayed in the operation display unit 7, which correspond to a plurality of print jobs generated by the digital copying machine 1, the first region marker display unit 14 may be configured so as to set different region markers with respect to the segment regions as shown in FIG. 10. For example, a configuration in which the type of the region marker to be displayed for each print job can be selected by a user through the operation display unit 7 when each print job is generated, and at the same time, the type of region marker that has already been selected for a print job cannot be selected for other print jobs to be generated later, will allow a user to set different types of region markers to the segment regions. Accordingly, it is possible to prevent misidentification of the print jobs, which is caused by simultaneously displaying a plurality of the same type of markers. In addition, the region markers may be set as needed by displaying a marker setting screen, for example.

The above described embodiment describes a situation in which the second region marker display unit 24 can display and superimpose a predetermined color that functions as a region marker on a segment region in the progress display bar 20 displayed in the information processing device 8a, which corresponds to a print job output from the information processing device 8a. However, the region marker is not limited to a predetermined color, and a variety of patterns or signs can be selected as the region marker as needed. In addition, if there is a plurality of segment regions in the progress display bar 20 displayed in the information processing device 8, which correspond to a plurality of print jobs output from the information processing device 8a, the second region marker display unit 24 may be configured so as to set different region markers to the segment regions. For example, a configuration in which a region marker for a print job can be selected by a user through the information processing device 8a when the print job is output, and at the same time, the type of region marker that has already been selected for a print job cannot be selected for other print jobs to be output later, will allow different region markers to be respectively set to the segment regions. Accordingly, it is possible to prevent misidentification of the print jobs, which is caused by simultaneously displaying a plurality of the same type of markers. In addition, the region markers can be set as needed by displaying a marker setting screen, for instance.

The above described embodiment describes a situation in which the first basic attribute display unit 16 can instruct the operation display unit 17 to display a basic attribute of a print job corresponding to a segment region in the progress display bar 20, which is selected by a user through the operation display unit 7. However, the first basic display unit 16 may be configured to display a basic attribute of a print job corresponding to a segment region only when the segment region in the progress display bar 20 which corresponds to the print job generated in the digital copying machine 1 is selected. Because of this, it is possible to prevent confidential information from being leaked to other users, which occurs when a basic attribute of another print job is displayed.

The above described embodiment describes a situation in which the second basic attribute display unit 26 can instruct the information processing device 8a to display a basic attribute of a print job corresponding to a segment region in the progress display bar 20, which is selected by a user through the information processing device 8a. However, the second basic attribute display unit 26 may be configured to display a basic attribute of a print job corresponding to a segment region only when the segment region in the progress display bar 20 which corresponds to a print job output from the information processing device 8a is selected. Because of this, it is possible to prevent confidential information from being leaked to other users, which occurs when a basic attribute of another print job is displayed.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A job progress display device that is configured to display the progress of a plurality of print jobs for which a spool process is executed, comprising:
a progress display bar display unit configured to display the progress of the plurality of print jobs as a progress display bar, the progress display bar display unit displaying the order in which the plurality of print jobs will be processed, and the quantity of data in each print job, by means of segment regions in the progress display bar.

2. The job progress display device according to claim 1, further comprising:
a region marker display unit configured to display a marker with respect to a predetermined segment region in the progress display bar.

3. The job progress display device according to claim 2, wherein the marker display unit will regulate the types of markers to be displayed so that the markers will be different from each other when displaying markers with respect to a plurality of segment regions.

4. The job progress display device according to claim 1, further comprising:
a despool marker display unit configured to display a marker with respect to a segment region in the progress display bar which corresponds to a print job for which a despool process is being executed.

5. The job progress display device according to claim 1, further comprising:
a basic attribute display unit configured to display an attribute of a print job corresponding to a selected segment region in the progress display bar.

6. The job progress display device according to claim 1, further comprising:
a detailed attribute display unit configured to display detailed attributes of a print job that has been selected for deletion.

7. A job progress display method for displaying the progress of a plurality of print jobs for which a spool process is executed, the method comprising the step of displaying a progress display bar that is divided into segment regions so that the order in which the plurality of print jobs, and the quantity of data in each of the print jobs, can be identified.

8. The job progress display method according to claim 7, wherein a marker is displayed with respect to a predetermined segment region in the progress display bar.

9. The job progress display method according to claim 8, wherein markers are displayed with respect to a plurality of segment regions, and regulated so as to be different from each other.

10. The job progress display method according to claim 7, wherein a marker is displayed with respect to a segment region in the progress display bar, the marker corresponding to a print job for which a despool process is being executed.

11. The job progress display method according to claim 7, wherein an attribute of a print job corresponding to a selected segment region in the progress display bar will be displayed.

12. The job progress display method according to claim 7, wherein an attribute of a print job that is selected for deletion will be displayed.
